(19) United States
(12) Patent Application Publication
(10) Pub. No.: US 2026/0104907 A1
(43) Pub. Date: Apr. 16, 2026

(54) Method and apparatus for checking an execution of a bytecode instruction

(71) Applicant: SICK AG, Waldkirch (DE)

(72) Inventors: Pascal LIEGIBEL, Waldkirch (DE); Thomas NEUMANN, Schallstadt (DE)

(21) Appl. No.: 19/250,945

(22) Filed: Jun. 26, 2025

(30) Foreign Application Priority Data
Jul. 26, 2024 (EP) 24191100.7

(51) Int. Cl. G06F 9/455

(52) U.S. Cl. CPC G06F 9/45533

(57) ABSTRACT

A method for checking an execution of a bytecode instruction of a safety program comprises: executing the bytecode instruction in a virtual machine; and checking by means of the virtual machine whether the bytecode instruction was executed correctly.

The invention relates to methods and apparatus for checking an execution of a bytecode instruction.

The bytecode instruction can be executed in a production cell. A production cell, which can consist of a robot, a machine and safety devices, can be a type of automated production system that can be adapted to perform a specific task safely and efficiently. The robot can be responsible for handling the workpiece and for transporting it between different machines and workstations. The machine can carry out the actual production process, for example welding, cutting or assembly. The safety devices can be adapted (for example, by executing a safety program) such that they protect workers from all hazards associated with the production process.

The manufacturing process can be protected by a program that is written in a higher programming language and executed on a controller. This program can be called a safety program.

This program can be responsible for performing various safety operations, such as stopping the robot or the machine when a worker enters the work cell; or, for example, preventing the robot or the machine from starting until all the safety devices are present and function properly; or, for example, limiting the speed and the range of motion of the robot or the machine to prevent collisions with workers or other objects; or, for example, monitoring the manufacturing process for irregularities or problems and shutting down the robot or the machine, if necessary.

By using a higher programming language, the safety program can be made more complex and sophisticated so that it can handle a wider range of dangers and provide a higher level of safety to the workers.

Safety programs protect humans from machines; therefore, they must be protected from these errors:
1) Random hardware errors: they can occur in any electronic device, including the controller that executes the safety program. They can be caused by manufacturing defects, wear or environmental factors. If a random hardware error occurs, the safety program can malfunction, which can lead to a safety risk.
2) Environmental interferences: this can be caused by electromagnetic interference (EMI), radio frequency interference (RFI) or electrostatic discharge (ESD). EMI and RFI can be caused by other electronic devices in the production cell, such as motors, welding devices and power lines. ESD can be caused by contact with a charged object, such as a person's body or a device. For example, a strong EMI signal could cause the safety program to misinterpret a safety sensor signal and to think that there is no danger even though there is a danger.
3) Operating system errors: operating systems are complex software systems and can contain errors. If an error occurs in the operating system, this can cause the safety program to crash or behave unexpectedly. An error could, for example, result in the safety program no longer being executed and the production cell thus being protected from danger.
4) Interfering software errors: this can happen if software is installed that has not been specifically developed for working with the safety program. This software could contain other application programs, malware or even system utilities. For example, a virus could be installed on the controller and could change the safety program, whereby malfunctions or a deactivation result.

It is an object of the invention to provide apparatus and methods that eliminate or avoid the errors described above. According to the invention, one solution is to create a bytecode virtual machine (BVM, or just virtual machine, VM for short) in software that recognizes these errors. A BVM is a computer that is simulated in software and that can be executed on a physical computer. It creates an environment that behaves like/simulates a computer, but can recognize the above-mentioned errors in the underlying hardware and in the operating system and can handle them in a controlled manner, e.g. to shut down the safety program properly in the event of memory errors.

The object is satisfied by a method for checking an execution of a bytecode instruction of a safety program having the features of claim 1 and by an apparatus for checking an execution of a bytecode instruction of a safety program having the features of claim 13.

A method according to the invention for checking an execution of a bytecode instruction of a safety program comprises: executing the bytecode instruction in a virtual machine; and checking by means of the virtual machine whether the bytecode instruction was executed correctly.

A virtual machine can therefore be provided that not only executes the bytecode, but simultaneously checks whether the bytecode was executed correctly. In this respect, the virtual machine can use any conventional bytecode; the bytecode can therefore be generated as usual by compilation (i.e. no special compiler is required), and bytecode that has already been generated can be used (i.e. it does not have to be recompiled for the checking or for the use with the virtual machine that checks the correct execution).

A bytecode instruction can also be called bytecode for short. However, bytecode (or a bytecode program) can also refer to a plurality of bytecode instructions.

The safety program can perform a safety or protection task, for example, preventing a collision between a human and an object, such as a robot. A safety program can consist of a plurality of logic units that can be distributed across a plurality of physical nodes. A safety program can also contain safety-relevant configurations.

The method according to various embodiments can be used to split imperative logic into atomic actions and to safely execute these atomic actions. It can enable the recognition of errors in the underlying hardware and software if functional, safety-relevant logic is evaluated that is specified in a higher programming language, e.g. Lua.

A time-consuming implementation of functional safety logic with conventional technology stacks that are used in safety software development can be avoided. Conventional technology stacks work directly on the underlying hardware without an additional software layer that monitors the proper functioning of the hardware. The method according to various embodiments can, for example, be used for safe container orchestration software (as described, for example, in European patent applications 24 176 635.1 and 24 176 655.9), software-based safe sensors and/or for safety controllers.

A bytecode can be a type of intermediate code that is generated by a compiler from a higher programming language source code. The bytecode can be a machine-independent code that can be interpreted by a virtual machine (VM) or compiled and executed just-in-time. Bytecodes can offer platform independence and an optimization of the program code.

Bytecode is not fixed to a specific hardware architecture or written for a specific hardware architecture. Instead, bytecode is intended for a virtual machine that can be implemented on different platforms. This enables the execution of the same bytecode on different operating systems and hardware types.

Bytecode can serve as an intermediate layer between the source code of a high-level language (such as Java or Python) and the machine code that is executed directly by the hardware. This intermediate layer can facilitate the portability and maintainability of the code.

A virtual machine (VM), such as the Java Virtual Machine (JVM) or the Python Virtual Machine (PVM), can read and execute the bytecode. This VM can either interpret the bytecode by executing it step by step or convert it into machine code (also known as just-in-time compilation) to speed up execution.

A virtual machine (VM) is software that creates a virtual environment that can function as an independent computer system. The VM makes it possible to execute programs as if they were running on a physical machine, although they are actually running on a host system within an isolated software environment.

A VM can run isolated from the host operating system and other VMs on the same host. A VM can share the physical resources (such as CPU (Central Processing Unit), memory or hard disk) of the host system. A virtualization layer can ensure that the resources are allocated efficiently and that multiple VMs can run independently of one another. VMs can provide an abstraction of the hardware so that it appears as if each VM has its own CPU, its own memory, its own hard disk, etc., even though these resources are shared with other VMs.

In one embodiment, the bytecode instruction is or includes an execution control instruction. The checking by the virtual machine whether the bytecode instruction was executed correctly can then include or be a checking of a checksum. For example, the checking can provide a diagnostic of the execution control. For example, a call stack and/or a bytecode stream can be protected by using checksums.

In one embodiment, the bytecode instruction is or includes an instruction to change a variable. The checking by the virtual machine whether the bytecode instruction was executed correctly can then include or be a redundant storage of the variable. For example, the checking can provide a diagnostic of global variables. For example, operations in the global variable space can be diagnosed by a redundant storage of inclusion/exclusion checksums.

In one embodiment, the bytecode instruction is or includes an instruction to execute an arithmetic operation. The checking by the virtual machine whether the bytecode instruction was executed correctly can then include or be a checking of a result of the arithmetic operation. Alternatively or additionally, the checking by the virtual machine whether the bytecode instruction was executed correctly can include or be an inverse arithmetic operation to the arithmetic operation. For example, the monitoring can provide a diagnostic of arithmetic (or algorithmic) operations. For example, arithmetic (or algorithmic) operations can be diagnosed by checking their results, for example by calculating the inverse operation and/or by comparing the result with the input value.

The method can execute a plurality of bytecode instructions (which can then be called a bytecode program). In this respect, the bytecode instructions can include different types of instructions (for example, execution control instructions and/or instructions to change a variable and/or instructions to execute an arithmetic operation).

In one embodiment, the virtual machine can be executed in a container that is managed by orchestration software. This can take place in Kubernetes, for example.

Alternatively, the virtual machine can be executed in a standalone container or in standalone hardware.

The virtual machine can be configured and used to execute a safety program for the production environment. The safety program can contain a plurality of bytecode instructions. In the production environment, machines (such as robots or machine tools) can work together with humans and/or humans can be present in the production environment to operate or maintain the machine.

The object of the invention is further satisfied by an apparatus for checking an execution of a bytecode instruction of a safety program. In this respect, the apparatus has a device (e.g. a computer system) for providing a virtual machine that is configured to execute the bytecode instruction. The virtual machine is further configured to check whether the bytecode instruction was executed correctly.

A production environment that includes a machine (for example, a robot and/or a machine tool) and the apparatus described herein for checking an execution of a bytecode instruction of a safety program can further be provided. The virtual machine can then be configured to execute a safety program for the production environment, wherein the safety program includes a plurality of bytecode instructions.

A computer readable storage medium can further be provided that comprises commands that, on execution by a computer, cause it to carry out the method described herein.

Further advantageous embodiments of the method according to the invention result from the dependent claims, from the drawing, and from the description.

The invention will be described in the following with reference to embodiment examples and to the drawing. There are shown in schematic representations:

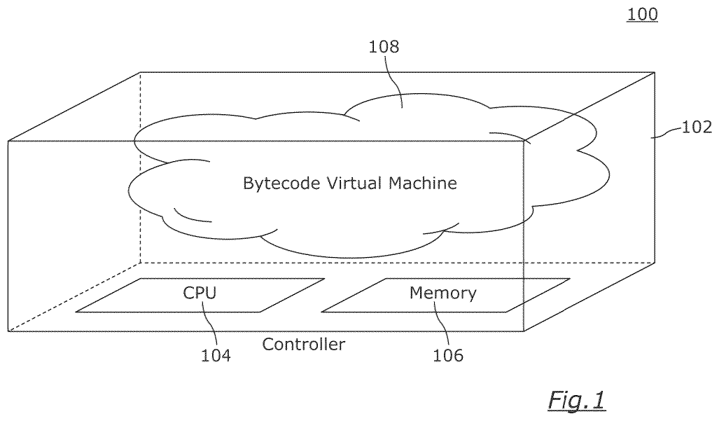

FIG. 1 a representation of a controller according to an embodiment;

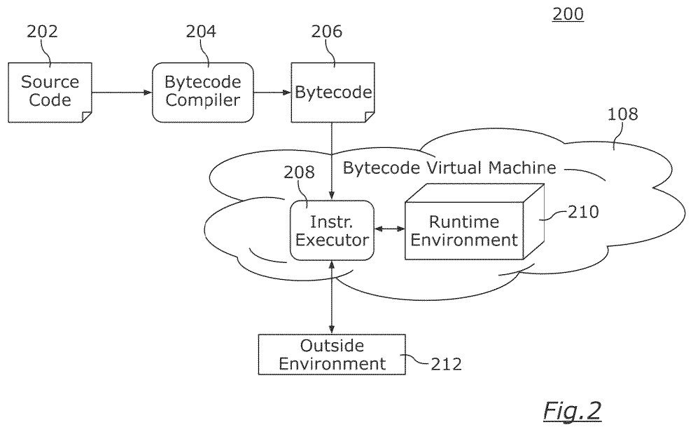

FIG. 2 an illustration of the bytecode virtual machine in the environment according to the invention;

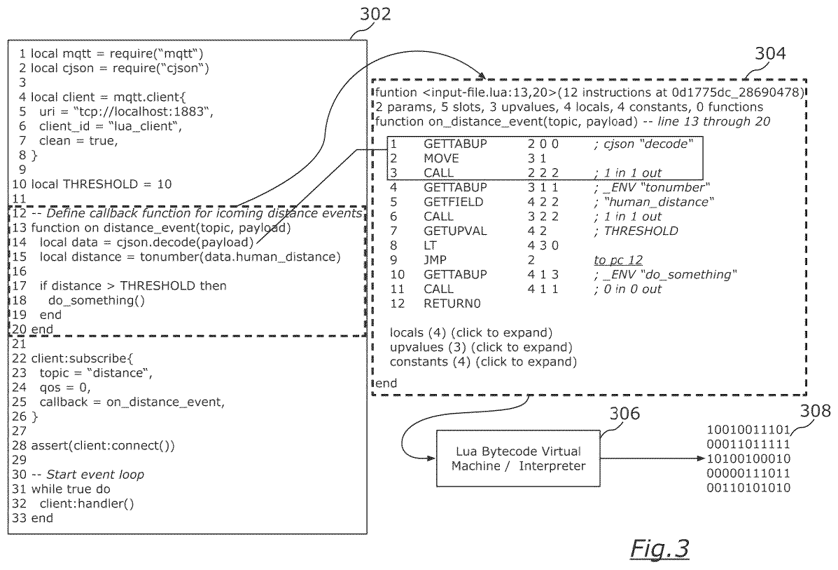

FIG. 3 an illustration of a source code that is compiled into a bytecode that is translated into machine code via a virtual machine; and

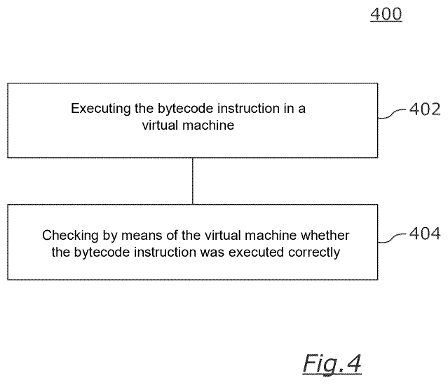

FIG. 4 a flowchart that illustrates a method for checking an execution of a bytecode instruction of a safety program according to an embodiment.

In the following, the methods and apparatus according to the invention will be explained in an exemplary manner with reference to embodiment examples.

FIG. 1 shows a representation 100 of a controller 102 according to an embodiment. The controller 102 can include a CPU (Central Processing Unit) 104, a memory 106 and a bytecode virtual machine 108 (BVM).

A BVM-based safety program can be executed in the BVM 108 that is located next to the robot and machine control programs running on the controller. The safety program is thereby isolated from errors that occur in the robot or machine control programs.

The BVM-based safety program can use various techniques for recognizing errors, such as checking the integrity of the safety program itself and/or monitoring the underlying hardware for errors.

If the BVM 108 recognizes an error either in the safety program itself or in the underlying operating system or the hardware, it can immediately stop the execution of the safety program and send a signal so that the robot and the machine can put the overall system in a safe state. This can prevent the robot or the machine from continuing to operate and a safety risk from possibly arising.

FIG. 2 shows an illustration 200 of the bytecode virtual machine 108 in the environment according to the invention. A source code 202 can be converted into a bytecode 206 by a bytecode compiler 204. The bytecode 206 can be forwarded to a command executor 208 within the bytecode virtual machine 108 and can be executed in a runtime environment 210. The execution of the bytecode can have effects on the environment 212 outside the bytecode virtual machine 108.

The bytecode instructions 206 represent the logic of a safety program for the BVM 108. They can be similar but not identical to the assembler that is generated for the command set of a specific hardware architecture. The bytecode instructions 206 can be similar to the assembler in that they contain only low-level instructions such as:
execution control (for example, managing a call stack, e.g. pushing and popping a value to or from the stack, branching to an item in the generated instruction list);
managing global variables (for example, managing a global variable range, e.g. reading and writing variables of a specific type);
algorithmic or arithmetic operations (for example, executing basic algorithmic or arithmetic operations, e.g. adding, subtracting, dividing and multiplying variables of a specific type).

However, the bytecode instructions 206 can differ from the assembler in that the bytecode instructions 206 are not limited to a command set that can be executed by actually present hardware (e.g. X86, ARM, . . .). The bytecode instructions 206 are tailored to the BVM 108 that may be independent of the underlying hardware.

The bytecode instructions 206 can indeed be reduced to the above-mentioned categories (i.e., execution control, global variables, and algorithmic or arithmetic operations), but further hardware-related instructions, such as instructions for configuring the hardware or memory management parameters, may be missing.

A safety program can consist of a stream of bytecode instructions. This stream of bytecode instructions can be generated by a compiler (e.g. bytecode compiler 204) that analyzes a higher-level programming language and converts the higher-level instructions into a stream of bytecode instructions. This stream of bytecode instructions is then passed to the bytecode VM to execute the logic of the safety program.

The command executor 208 (which can also be called an instruction executor) can read the stream of bytecode commands 206 individually and executes them. Each bytecode command 206 typically performs a simple operation, e.g. loading a value from the memory, executing an arithmetic operation, or branching to another part of the stream of bytecode commands 206. The identified atomic actions can be individually executed in a sequence.

The runtime environment 210 can provide the command executor 208 with the resources it needs to execute the bytecode command stream 206. These resources can include a memory manager for allocating and managing the memory for the bytecode program, and/or a stack for storing temporary values and operands, and/or a class loader for loading classes and resources, and/or a garbage collector for releasing unused memory.

The runtime environment 210 can furthermore provide a set of standard libraries which the bytecode program 206 can use. These libraries can contain functions for executing general operations such as reading and writing files, and/or editing strings and networks.

Such a bytecode VM approach can be found in various modern programming languages, e.g. Python, Java and Lua.

FIG. 3 shows an illustration 300 of a source code 302 that is compiled into a bytecode 304 that is translated into machine code 308 via a virtual machine 306. In the example of FIG. 3, a function is shown that receives a payload and checks it against a defined threshold value. It is shown how the source code 302 is translated at a high level into bytecode 304 and is executed by the BVM as binary code 308. For example, the bytecode “GETTABUP 2 0 0” calls up the decode function from the cjson table and stores it in register 2, “MOVE 3 1” moves the value from register 1 (payload parameter) to register 3, and “CALL 2 2 2” calls up the function in register 2 (decode) with 2 arguments (registers 2 and 3) and two results and decodes the json payload and stores the result in register 2.

One difference between a conventional bytecode VM and a bytecode VM according to various embodiments (which can be called a safe bytecode VM) may be, among other things, that the safe bytecode VM can immediately check the execution of every single bytecode command. Since the bytecode VM itself and the execution of the individual commands are implemented in software, the safe bytecode VM offers the option of safeguarding these command categories by integrating additional diagnostic logic. During the execution, all the changes to data or system resources in the runtime environment can be checked immediately. After each executed bytecode command, it can be checked whether the execution was consistent and correct. If the execution is not consistent and correct or the changes to the runtime environment are corrupted or manipulated, the execution of the bytecode command stream is aborted. This means that an immediate diagnosis of the result of the bytecode commands can take place.

Additional diagnostic logic can be provided in the bytecode VM according to various embodiments: diagnostics of the execution control (call stack and bytecode stream can be protected by using checksums), and/or diagnostics of global variables (operations in the global variable space are diagnosed by a redundant storage of inclusion/exclusion checksums), and/or diagnostics of algorithmic or arithmetic operations (algorithmic or arithmetic operations can be diagnosed by checking their results, e.g. inverse operation and comparison of the result with the input value).

All these diagnostic measures can be integrated into the command executor and can be triggered when the bytecode command stream is run through.

For example, the sequence of diagnostic measures can be as follows:
a. The command executor starts and checks the integrity of the loaded bytecode stream, for example by comparing checksums.
b. Global variables are assigned and equipped with diagnostic measures, for example, a variable is allocated twice to different memory locations and/or memory layouts.
c. The execution of the bytecode operations is started, wherein
i. the consistency of the bytecode command stream is verified by constantly monitoring its checksum;
ii. the monitoring of the execution time and the branch execution takes place via a watchdog mechanism and the monitoring of the program pointer takes place within the command executor.
d. The various bytecode commands are executed until the program logic is terminated or a critical situation is recognized. The execution of the bytecode commands is diagnosed either via the algorithmic operating diagnosis or the global variable diagnosis.

In this way, critical situations in the underlying hardware can be safely diagnosed and the command executor can always be able to stop the bytecode execution and trigger operations to bring the enclosing system—in which the bytecode VM is executed—into a safe state.

The (safe) BVM can be executed in a container that is managed by orchestration software such as Kubernetes (for example, by safe container orchestration software as described, for example, in European patent applications 24 176 635.1 and 24 176 655.9), or in a standalone container that is managed by a simple container engine such as Docker or Podman, or as a standalone binary file/process directly on a host operating system and a hardware appliance (for example, a controller or sensor with sufficient hardware resources without any containerization).

A bytecode compiler can convert instructions of a higher programming language into a bytecode instruction stream that is suitable for the BVM before said stream can be executed.

FIG. 4 shows a flowchart 400 that illustrates a method for checking an execution of a bytecode instruction of a safety program according to one embodiment. In 402, the bytecode instruction is executed in a virtual machine. In 404, the virtual machine checks whether the bytecode instruction was executed correctly.

The methods and apparatus according to various embodiments can provide a high efficiency: modern, more expressive programming languages can be used to easily implement safety-critical solutions in a soft real-time environment.

The methods and apparatus according to various embodiments can provide cost savings: standard hardware can be used to perform safety-critical solutions.

The methods and apparatus according to various embodiments can provide security: existing hardware that is not intended for safety-critical solutions can be used and this hardware can be used as part of a safety solution, which makes new application scenarios possible.

The methods and apparatus according to various embodiments can enable isolation: a BVM-based safety program can be isolated from the robot control programs and machine control programs and from the operating system. This can provide a controlled environment, sandboxing and access control, whereby the program security and robustness can be improved and the program can be more resistant to errors that occur in other programs or processes.

The methods and apparatus according to various embodiments can provide portability: a BVM-based safety program can be ported to various hardware platforms. This can facilitate the use of the same safety program for different robots and machines.

The methods and apparatus according to various embodiments can provide scalability: a BVM-based safety program can be scaled to support more robots and machines. This can make it a good solution for large production facilities.

### REFERENCE NUMERAL LIST

100 representation of a controller according to an embodiment
102 controller
104 CPU
106 memory
108 bytecode virtual machine
200 illustration of the bytecode virtual machine in the environment according to the invention
202 source code
204 compiler
206 bytecode
208 command executor
210 runtime environment
212 environment outside the bytecode virtual machine
300 illustration of a source code that is compiled into a bytecode that is translated into machine code via a virtual machine
302 source code
304 bytecode
306 virtual machine
308 machine code
400 flowchart that illustrates a method for checking an execution of a bytecode instruction of a safety program according to an embodiment
402 step of executing the bytecode instruction in a virtual machine
404 step of checking by means of the virtual machine whether the bytecode instruction was executed correctly

1. A method for checking an execution of a bytecode instruction of a safety program, the method comprising:
executing the bytecode instruction in a virtual machine; and
checking by means of the virtual machine whether the bytecode instruction was executed correctly.

2. The method according to claim 1, wherein the execution of the bytecode instruction of a safety program takes place in one of an industrial plant and an automated production system.

3. The method according to claim 1,
wherein the bytecode instruction has an execution control instruction.

4. The method according to claim 3,
wherein the checking by the virtual machine whether the bytecode instruction was executed correctly comprises checking a checksum.

5. The method according to claim 1,
wherein the bytecode instruction has an instruction to change a variable.

6. The method according to claim 5,
wherein the checking by the virtual machine whether the bytecode instruction was executed correctly comprises a redundant storage of the variable.

7. The method according to claim 1,
wherein the bytecode instruction has an instruction to execute an arithmetic operation.

8. The method according to claim 7,
wherein the checking by the virtual machine whether the bytecode instruction was executed correctly comprises checking a result of the arithmetic operation.

9. The method according to claim 7,
wherein the checking by the virtual machine whether the bytecode instruction was executed correctly has an inverse arithmetic operation to the arithmetic operation.

10. The method according to claim 1,
wherein the virtual machine is executed in a container that is managed by orchestration software.

11. The method according to claim 1,
wherein the virtual machine is executed in a standalone container.

12. The method according to claim 1,
wherein the virtual machine is executed in standalone hardware.

13. The method according to claim 1,
wherein the virtual machine is further configured to execute the safety program for the production environment comprising a plurality of bytecode instructions, wherein the production environment has a machine.

14. An apparatus for checking an execution of a bytecode instruction of a safety program, the apparatus comprising:
a device for providing a virtual machine that is configured to execute the bytecode instruction;
wherein the virtual machine is further configured to check whether the bytecode instruction was executed correctly.

15. A production environment comprising a machine and the apparatus according to claim 14, wherein the virtual machine is further configured to execute the safety program for the production environment comprising a plurality of bytecode instructions.

16. A computer readable storage medium comprising commands that, on
execution by a computer, cause it to carry out a method for checking an execution of a bytecode instruction of a safety program, the method comprising:
executing the bytecode instruction in a virtual machine; and
checking by means of the virtual machine whether the bytecode instruction was executed correctly.
